(19) United States
(12) Patent Application Publication
(10) Pub. No.: US 2015/0357056 A1
(43) Pub. Date: Dec. 10, 2015

(54) REACTOR UNIT CONTROL SYSTEM FOR SPACE AND TERRESTRIAL APPLICATIONS

(71) Applicant: COLORADO SCHOOL OF MINES, Golden, CO (US)

(72) Inventor: Zeev Shayer, Littleton, CO (US)

(21) Appl. No.: 14/682,679

(22) Filed: Apr. 9, 2015

Related U.S. Application Data
(60) Provisional application No. 61/977,375, filed on Apr. 9, 2014.

(51) Int. Cl. G21C 7/28

(52) U.S. Cl. CPC G21C 7/28

(57) ABSTRACT

A reactor energy system comprises a reactor core and a control system. The control system includes one or more rotating reflectors or control drums formed of a primary reflector material and a lesser reflector disposed on a selected surface. The reflected neutron flux is regulated by rotating the reflector with respect to the reactor core, increasing the reflected neutron flux when the primary reflector is disposed proximate or toward the reactor core, and decreasing the reflected neutron flux when the secondary neutron reflector is disposed proximate or toward the reactor core.

### CROSS-REFERENCE TO REPLATED APPLICATIONS

This application claims the benefit of priority pursuant to 35 U.S.C. §119(e) of U.S. Provisional Patent Application No. 61/977,375, filed Apr. 9, 2014, which is hereby incorporated by referenced in its entirety.

### BACKGROUND

This disclosure is directed to nuclear reactor control systems, including, but not limited to, small scale reactor units for space-based and terrestrial applications. In particular, this disclosure is directed to reflector-based nuclear reactor control systems, with improved neutron reflection and parasitic absorption properties.

One of the current challenges facing small-scale power applications is the need for an energy source capable of providing useful energy for the entire mission duration or product lifetime. Historically, radioisotope batteries have been used to provide load power in spacecraft, underwater systems, and remote scientific stations, but these systems are not capable of the load flexibility and higher power requirements that more advanced fission energy systems provide. To remedy this, many forays into nuclear powered spacecraft have been investigated, but no completely suitable, robust system for long-term high density power generation has been found.

Nuclear reactors rely on the process of nuclear fission to generate power. Protons and neutrons make up the nucleus, and are the building blocks for all nuclear reactions including not only radioactive decay and fission, but also fusion processes. More specifically, the number of protons in the nucleus determines the atomic number (that is, which element is present), while the number of neutrons determines the atomic mass of each specific isotope. While the physical and chemical properties of different isotopes may be similar, as determined by the atomic number of the element, the nuclear properties can be vastly different. Neutrons are also important to the fission process through their interaction properties, including elastic and inelastic scattering, and neutron absorption.

Neutron absorption causes the nucleus to become more energetic. The excited nucleus can achieve de-excitation by emission of a gamma ray (γ), which does not change the radioactive isotope, or through alpha (α) or beta (β) emission. In alpha emission, an alpha particle (a helium nucleus consisting of two protons and two neutrons) is ejected, lowering the nuclear energy state and reducing both the number of protons and the number of neutrons by two. In beta emission, a neutron (n) can be converted into a proton (p) by emission of positron (e⁺) and an electron neutrino (vₑ), or a neutron can be converted into a proton by emission of an electron (e⁻) and an antineutrino.

In special cases, unstable nuclei can reach a lower total energy state by splitting into two or more pieces or fission products. Fission processes can also emit additional neutrons, so there may be more free neutrons present at the end of a fission reaction than there were at the beginning. It follows that if a fission process occurs in a group of fissile atoms (say, in the middle of a fuel element), the emitted neutrons could repeat the process with other nearby atoms, starting a nuclear chain reaction.

In reactor theory, a fission system that creates exactly as many neutrons as it consumes is said to be exactly critical, and has a multiplication factor or “k value” of 1.0. If the reactor is consuming more neutrons than is creates, it is said to be subcritical and has k<1.0. Conversely, a supercritical reactor has a k>1.0, and creates more neutrons than it consumes.

Subcritical reactors do not sustain chain reactions, while supercritical reactors are difficult if not impossible to control. Thus, power reactor designs typically operate with a goal of approximately k=1.0.

Because not all neutron absorptions lead to fission, it is often beneficial to examine the number of neutrons emitted per absorption in the fuel or other reactor mass. This is commonly denoted as 11, and can be defined by the following equation, where the numerator and the denominator are the microscopic fission and macroscopic absorption cross sections, respectively:

$$η = v \frac{{σ}_{f}^{F}}{{σ}_{a}^{F}} . \qquad [ 1 ]$$

The total absorption cross section σₐ for a particular fuel includes any reaction that leads to neutron absorption, regardless of outcome, including alpha, beta and gamma decays as well as the nuclear fission cross section σ_{f}. In order to maintain criticality η must be large enough to account for leakage and parasitic absorption, and materials with η≈1.5 or higher may be considered suitable for use as nuclear fuels.

Neutron scattering and absorption cross sections are highly energy dependent, and the cross section for fission may increase substantially at energies on the order of about 1 keV or less. This is well below the typical neutron emission energy of a few MeV or more, so moderators such as graphite or beryllium may be used to slow or thermalize the neutron flux to the energy range that would increase the fission process probability. This tends to increase the fission cross section, as compared to fast neutron reactor designs, but there also materials (e.g., U-238) which are only fissile at high neutron energy.

Neutron “poisons” with high absorption cross section may also be produced as fission products, or used to control neutron populations in the reactor core as (e.g., using a metalloid such as boron or gadolinium absorbers). Reactor control is thus a highly complex and challenging area of nuclear systems design, in which there is a constant need for more robust and responsive control systems. The need extends to small-scale, remote, and space-based applications, where maintenance and service requirements are major design considerations.

### SUMMARY

This application is directed to reactor control systems and methods. The reactor may include a reactor core with a fuel assembly disposed inside a core barrel. The reactor core generates a neutron flux, based on a fission reaction rate in the fuel assembly. A reactor vessel can be disposed about the reactor core, with a neutron reflector disposed between the outer surface of the active core (where the fission process occurs) and the inner surface of the reactor vessel, or between the outer surface of the core barrel and the inner surface of the reactor vessel.

At least one rotary control element can be disposed within the reactor vessel, for example a number of control drums disposed about the circumference of the reactor core, or a ring or annular reflector disposed coaxially about the reactor core. The control element typically includes a “primary” reflector material configured to reflect the neutron flux back toward the reactor core, and a “lesser reflector” disposed on a selected surface of the primary. The lesser reflector can be formed of a metal such as aluminum or steel, and may be borated so as to have a boron-10 concentration that decreases the absorption rate as a function of exposure to the neutron flux during the reactor lifetime.

The control system can be configured to regulate the neutron population inside the active core region and fission process by controlling reflected neutron flux back to the core based on rotation of the control drums or control ring, and thus to regulate the fission reaction rate within the reactor core. In particular, the reflected neutron flux depends upon the rotational or angular position of the control drums or control ring. In multiple drum embodiments, for example, the reflected neutron flux can be substantially greater with the primary reflectors disposed toward the reactor core, as compared to an angular position with the lesser reflector disposed toward the reactor core.

The reflected neutron flux also depends on the Boron-10 concentration, which decreases with exposure to the neutron flux. Thus, the reflected flux and reactor rate can also be controlled based on the burn rate of the borated lesser reflector, in order to maintain more efficient operation over the useful service life of the reactor system.

There are two approaches to regulating the neutron flux inside the reactor via leaking of neutrons from the active core region to the reflector. One approach is based on letting the neutrons stream through the reflector region to the outside of reactor region via void holes in the reflector, provided in different configurations and forms, which may create some radiation shielding problems. The second approach is directed to controlling the backscattering neutron population via absorption and/or by reducing the backscattering efficiency, similar to that of albedo boundary conditions, where less neutron current is reflected back to the active core region.

This disclosure encompasses the first option and the second option, which has advantages through the large attainable reactivity worth (and reactor safety), and better reactivity control during the core lifetime (including burnup of neutron absorbing material), and improving radiation protection for terrestrial applications. A combination of both approaches, is also a viable option in these designs, e.g., in rotating drum or ring configurations, by creating void channels through the borated aluminum (Al+B₄C) with or without other reflector material (e.g., Pb-208+Al+B₄C), all the way through the drum or other reflector element, providing a neutron path from the active reactor core to the outside of the reactor.

### BRIEF DESCRIPTION OF THE DRAWINGS

FIG. 1A is cross sectional view of a representative nuclear reactor energy system, taken in an axial direction.

FIG. 1B is a radial cross section view of the reactor energy system of FIG. 1A.

FIG. 2 is a cross sectional view of a fuel block for the reactor energy system of FIGS. 1A and 1B.

FIG. 3 is a cutaway view of a fuel particle or pellet for the fuel block of FIG. 2.

FIG. 4A is a schematic view of a reactor control system in a low reaction rate or OFF position.

FIG. 4B is a schematic view showing the reactor control system of FIG. 4A in a high reaction rate or ON position.

FIG. 4C is a detail view of a rotary control element or drum for the control system of FIGS. 4A and 4B.

FIG. 5 is a plot of scattering cross sections for different neutron reflectors.

FIG. 6A is a schematic view of the reactor control system with borated lesser reflectors, oriented in a low reaction rate or OFF position.

FIG. 6B is a schematic view showing the reactor control system of FIG. 6A in a high reaction rate or ON position.

FIG. 7A is a representative plot of different effective reaction rates for the reactor control system or FIGS. 6A and 6B, as a function of control angle.

FIG. 7B is a plot of maximum reactivity swing for the ON and OFF positions of FIGS. 6A and 6B, as a function of boron content.

FIG. 8A is summary of control parameters for the reactor control system of FIGS. 6A and 6B, as a function of boron content in the lesser reflector.

FIG. 8B is a summary of reactivity worth values for different lesser reflector designs.

FIG. 8C is a plot of reactivity worth as a function of reactor core age, for different control system designs.

FIG. 9A is a schematic view of a void channel reactor control system, in a low reaction rate or OFF position.

FIG. 9B is a schematic view showing the reactor control system of FIG. 9A in a high reaction rate or ON position.

FIG. 10A is a schematic view of an axially rotating reactor control system, in a low reaction rate or OFF position.

FIG. 10B is a schematic view showing the axially rotating control system of FIG. 10A in a high reaction rate or ON position.

FIG. 11A is a schematic view showing the axially rotating reactor control system of FIG. 10A with absorber plugs positioned in a shutdown configuration.

FIG. 11B is a schematic view showing the axially rotating reactor control system of FIG. 10B with absorber plugs positioned in an operating configuration.

FIG. 12A is a schematic view of a reactor control system with increased drum size, in a low reaction rate or OFF position.

FIG. 12B is a schematic view showing the reactor control system of FIG. 12A, in a high reaction rate or ON position.

### DETAILED DESCRIPTION

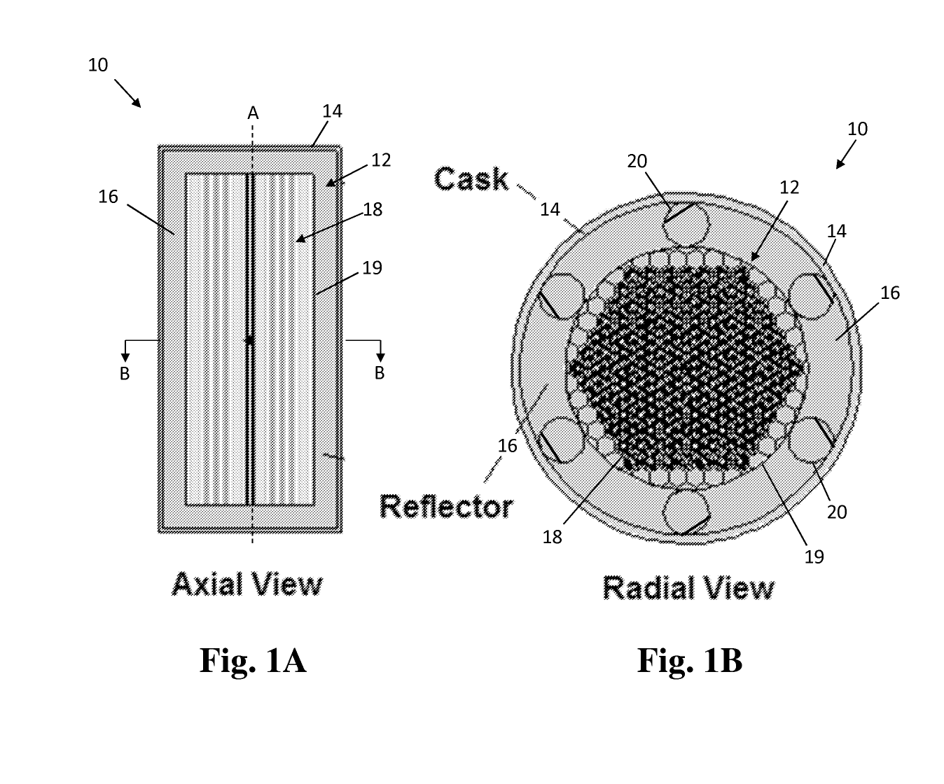

FIG. 1A is a cross sectional view of a representative nuclear fission reactor energy system 10, taken in an axial direction. In this particular configuration, reactor system 10 has a general cylindrical geometry with reactor core (or fuel core) 12 disposed inside a cylindrical cask or pressure vessel (or vessel wall) 14. Neutron reflector 16 is disposed about reactor core 12, for example using a layer of beryllium oxide (BeO) or other neutron reflector arranged between the outer circumference or surface of reactor core 12, and the inner circumference or surface of reactor vessel 14.

Reactor core 12 includes a number of fuel assemblies or block assemblies 18 formed of fuel blocks, fuel rods, fuel cells or other fuel elements, as described below, surrounded by a structural wall such as a core barrel 19 or thermal shield (or both). Reactor core 12 may also include additional neutron reflectors, moderators, absorbers and structural materials, and reactor system 10 may include a combination of active and/or passive fluid (liquid or gas) flow systems for heat extraction and cooling of reactor core 12. The heat can be utilized to generate power for external use, for example in a turbine-type generator operating on a Brayton or Stirling cycle, or via another thermodynamic or thermoelectric power generating process.

FIG. 1B is radial cross section view of reactor system 10, taken along line A-A of FIG. 1A. As shown in FIG. 1B, one or more (e.g., a plurality of) control drums or other control elements 20 are provided with non-uniform composition of materials having different nuclear properties, in order to control the fission reaction rate in reactor system 10 by rotation of control drums 20, and selective reflection and absorption of neutrons emitted from reactor core 12.

Reactor vessel 14 is typically formed of a structural metal such as stainless steel or aluminum. Depending on reactor size and environment, additional containment and shielding structures may also be provided, for example a single or double-walled pressure vessel, a reinforced concrete containment shell or other containment structure, or a combined pressure vessel and containment system.

The size scale of reactor system 10 and core 12 is determined based on fissile fuel type (e.g., enriched uranium, slightly enriched uranium, reprocessed uranium, highly enriched uranium, plutonium, or other actinide metal), fertile materials (e.g., thorium), and other design factors including active core radius, fuel spacing parameters such as fuel block flat-to-flat distance, and reflector thickness. Each of these parameters can be varied using a full model of the reactor core to determine power demands, service lifetime, and other operational considerations, until a suitable configuration is defined. The configuration of reactor system 10 may also depend upon a working model of the individual fuel elements or blocks, which is utilized to determine reaction products and reactivity trends that can affect reactor operation over the lifetime of core 12.

Suitable representative reactor power and energy control systems include, but are not limited to, those described in references 1-4, below, each of which is incorporated by reference herein. In particular, HTGR technology may be utilized with or without a thorium fuel cycle to design lightweight nuclear power sources capable of continuous electric power output of wide range from couple of kWe up 10 MWe or more, with long term operational periods of up to 15 years or more. In one such embodiment, the energy system may utilize a combination of fissile fuel (e.g., low and highly enriched uranium dioxide) and a fertile material (e.g., thorium carbide or natural UC), for example in a Tri-Structural Isotropic or TRISO fuel particle medium can be embedded in a graphite or beryllium oxide matrix (e.g., cylindrical pelts that forms hexagonal matrix block). As the primary fissile material is consumed in such a reactor system, the fertile material breeds new fissile fuel, resulting in a more steady fuel loading over the lifetime of the core.

Representative reactor designs may be selected based on reactor core and fuel block modeling, as described above, for example with a packing fraction of about 10-45% by volume fissile material 22 and about 10-50% by volume fertile material 28, or with a packing fraction of about 25±5% fissile uranium oxide and about 40±5% fertile thorium carbide. In particular examples, flat-to-flat distances of about 4 cm or below and up to about 10 cm or more may also be selected, in order to maintain a negative reactivity temperature component so that the fission reaction rate decreases with increasing core temperature for a given active core radius, e.g., about 50 cm or less, for example about 30 cm or less. Similarly, the active core height may be limited to about two meter or less, for example about 150 cm or less, or about 140 cm or less. At about 10 cm flat-to-flat distances, the reactivity temperature coefficient may become positive in some of designs, for example in a graphite moderated reactor core, which can be undesirable unless other methods are used to reduce the thermal neutron flux and resulting fission rate.

References. The following references are incorporated by reference herein, in their entirety and for all purposes:
1. Michael Worrall and Zeev Shayer, “Alternative Reactivity Control System for a Small Fission Power System for Space and Terrestrial Applications,” 2011 ANS winter meeting, Oct. 30-Nov.r 3, 2011 (invited).
2. M. Worrall and Z. Shayer, “HTGR Power System Technology for Space Exploration Missions,” Journal of the British Interplanetary Society, November/December 2010, Vol. 63, No. 11/12, pp. 449-453.
3. M. Worrall and Z. Shayer, “HTGR Power System Technology for Space Exploration Missions,” SPESIF-2011, Space, Propulsion & Energy International Forum, Mar. 15-17, 2011 (University of Maryland, College Park, Md.).
4. M. Worrall and Z. Shayer, “Reactivity Control Options for a Space Fission Systems,” NETS 2011, Nuclear and Engineering Technology for Space, SPESIF-2011, Space, Propulsion & Energy International Forum, Mar. 15-17, 2011 (University of Maryland, College Park, Md.).

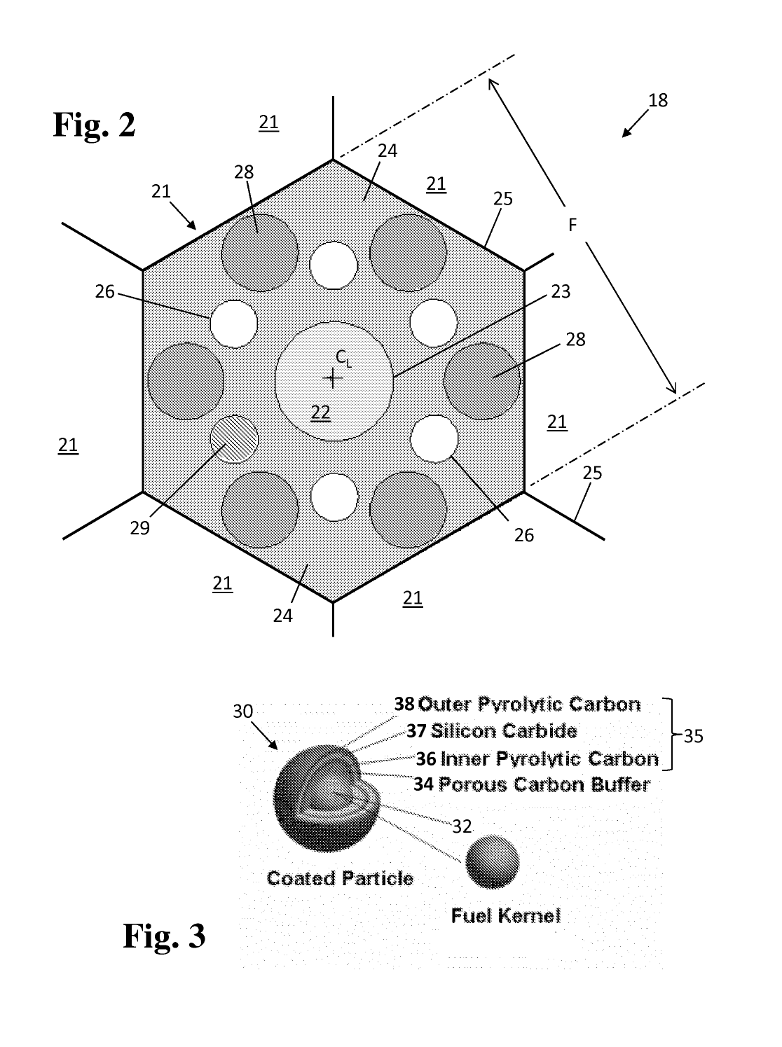

FIG. 2 is a cross sectional view of a fuel element or fuel block 21 for a reactor energy system (or power system) 10, for example as described with respect to FIGS. 1A and 1B, above. In the particular configuration of FIG. 2, fuel block 21 is formed around a fissile fuel material 22 within cladding 23, surrounded by a matrix block material 24 with outer wall 25 and internal channels 26 for circulating cooling fluid or other material. Depending on fuel cycle and other reactor design considerations, addition fuel or fertile material 28 may also be provided, as arranged within outer wall 25 of block matrix material 24.

Fuel 22 may be formed uranium, plutonium or mixed uranium/plutonium oxide, or another suitable fissile nuclear fuel such as a uranium-zirconium hydride (UZrH) material. Fuel 22 may be provided in pelletized, particle or microparticle form and stacked or poured along the central axis or centerline C_{L} of fuel block 21, within a suitable high temperature cladding material 23 such as a nickel-based superalloy or zirconium alloy. Depending reactor design, additional fuel 22 or fertile material 28 may also be included in different locations within fuel block 21, for example a fertile thorium, uranium or plutonium isotope that is converted into a fissile material by neutron interactions.

Block or matrix material 24 can be selected for a combination of high temperature structural characteristics in combination with selected nuclear reflection, moderation, and absorption properties, for example graphite (C) or beryllium oxide (BeO). In the particular example of FIG. 2, for example, a substantially uniform matrix material 24 extends to outer wall 25 of fuel block 21. Alternatively, different materials can be used, for example a combination of graphite and another moderator material such as beryllium oxide. Additional cladding or other structural materials can also be provided on outer wall 25.

Internal channels 26 are provided for cooling fluid flow, in order to achieve heat transfer from fuel block 21. Suitable cooling fluids include liquids and gases, for example an inert gas such as helium or argon, or a molten material such as a liquid fluoride salt. Depending on reactor design, other coolants such as water can also be used, and such materials may be selected for both cooling and neutron moderation properties. A neutron reflector or neutron absorber material 29 can be inserted into one or more internal channels 26, for example a pre-criticality safety rod made of boron carbide (B₄C).

As shown in FIG. 2, outer matrix wall 25 has a hexagonal configuration for close packing of adjacent fuel rods or fuel elements 21 in a prismatic block fuel arrangement, with flat with flat-to-flat spacing F selected based on core fuel radius, reactor design, fuel cycle, and other operational considerations. Other geometries are also possible, for example triangular, square or rectangular fuel blocks 21, which can also be close packed. Cylindrical rod geometries and other non-close packed configurations are also contemplated. In these designs, the gaps between adjacent fuel blocks 21 can either be left empty or used for cooling fluid flow, or provided with additional neutron moderator, neutron reflector or neutron absorbing matrix materials 24.

In some reactor designs, a tristructural isotropic (TRISO) or other microparticle fuel may be utilized, for example in a high temperature gas cooled reactor (HGTR) or very high temperature reactor (VHTR) system, or an advanced heavy water reactor (AHWR) design. Depending on application, such microparticle fuels can be dispersed in a moderating matrix (e.g. matrix material 24), with a homogenized fissile and fertile material composition. Alternatively, the fissile and fertile materials can be provided in separate sub-elements, for example with “pins” or cylinders of fertile material 28 arranged about the central fissile cylinder 22 or “pin” as shown in FIG. 2, in order to promote neutron propagation favorable for the conversion of the fertile isotopes into fissile fuel over the operational lifetime of the fuel core.

Fertile material cylinders 28 can also be either larger or smaller than the corresponding “pins” or cylinders of fissile material 22. Alternate configurations are also known, for example a simple stacked fuel rod assembly.

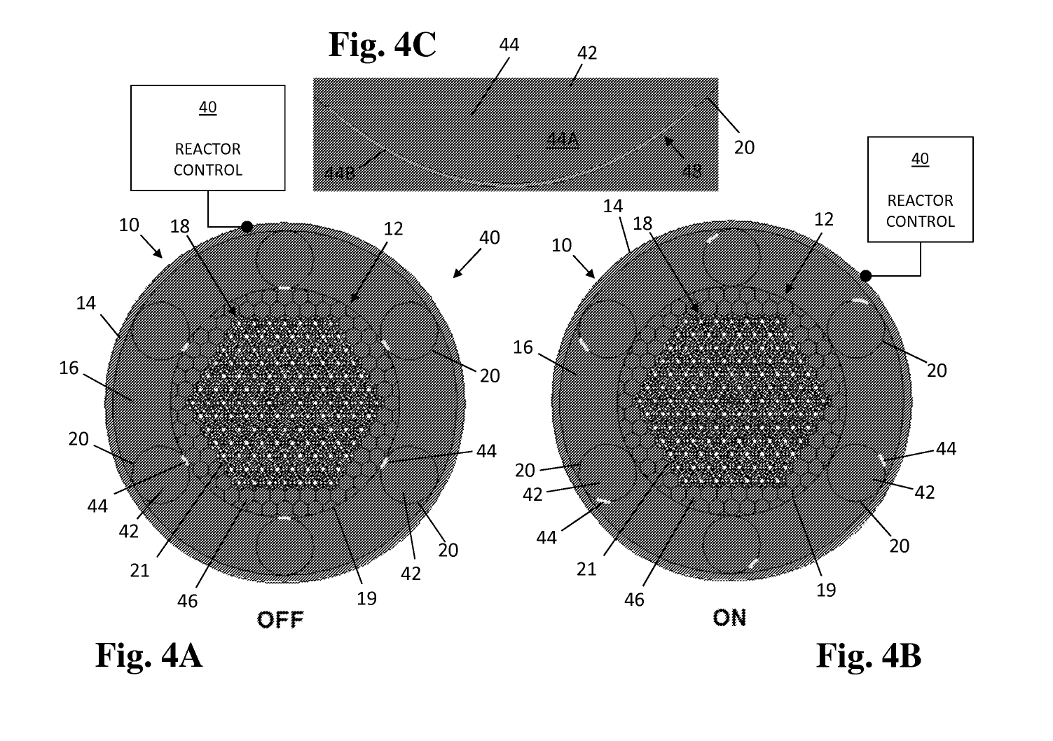

FIG. 3 is a cutaway view of a fuel pellet or particle 30, for example as provided in a structured fuel block 21 or homogenized fissile/fertile fuel system. As shown in FIG. 3, fuel pellet 30 is formed as a coated particle with inner fuel kernel 32 surrounded by one or more of buffer layer 34 and outer layer 35. In this particular configuration, outer layer 35 comprises inner pyrolytic layer 36, carbide layer 37, and outer pyrolytic layer 38.

Individual fuel pellets 30 range in size, for example from about 300 μm or less to about 500 μm or more, or from about 500 μm up to about 1 mm or more. The particular size and layer configuration also depends on the selected fuel in kernel 32, and the corresponding fuel cycle and other operational criteria of the reactor energy system.

Suitable fuel kernels 32 include both fissile and fertile materials, for example fissile isotopes in the form of uranium oxide (UO₂), uranium nitride (UN), or mixed uranium and plutonium oxide (MOX), or a fissile zirconium actinide alloy, as described above. Suitable fertile isotopes include uranium-238 and thorium-232, for example in the form of a uranium oxide, uranium carbide (UCx), thorium carbide (ThC) or thorium dioxide (ThO₂).

Buffer layer 34 may comprise a relatively low density pyrolytic carbon or pyrocarbon buffer material, selected to provide thermal and mechanical stress relief when during production of fission gases and other fission processes in fuel kernel 32. Outer layer 35 provides structural integrity and containment, for example utilizing a silicon carbide (SiC) diffusion barrier layer 37, with inner and outer pyrolytic carbon layers 36 and 38, as shown in FIG. 3.

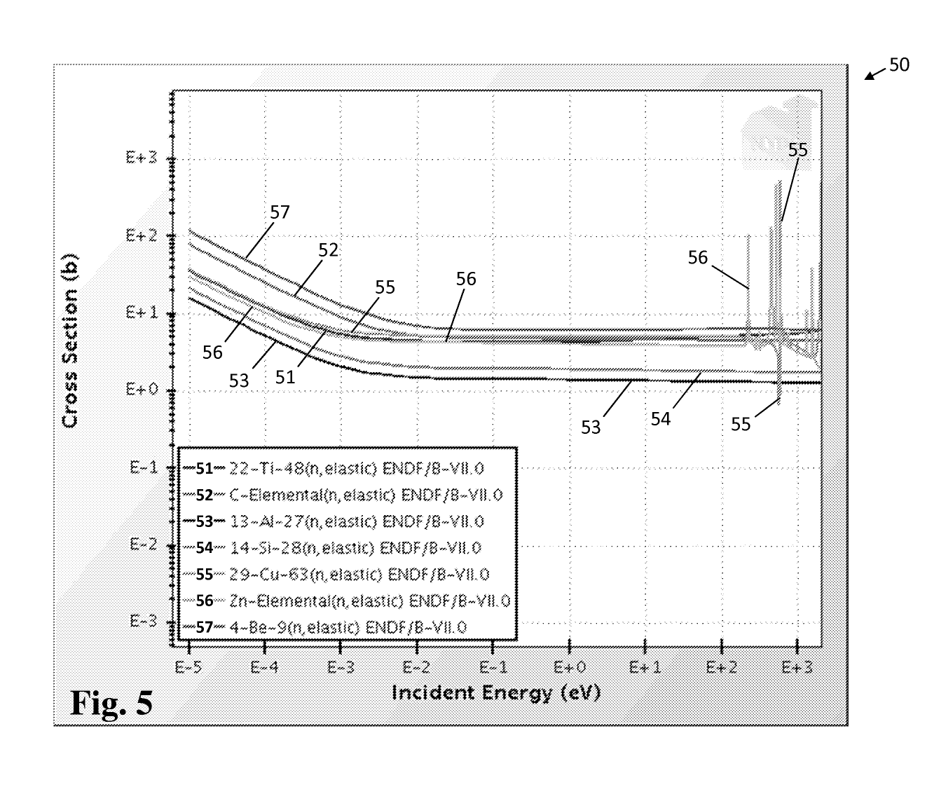

FIG. 4A is a schematic view of a parasitic absorber-based control system 40 for reactor energy system 10. Reactor system 10 includes a reactor core 12 with fuel assembly 18 comprising a number of fuel blocks 21 arranged within core barrel 19, as described above. Neutron reflector 16 is disposed between core barrel 19 of reactor core 12 and the inner surface of reactor vessel 14.

Control system 40 includes a number of control drums 20, each having a major or primary reflector portion 42 made of a neutron reflector material and a control feature 44 made of a parasitic absorber or lesser reflector material to control the backscattering neutrons, or a combination thereof. In the low reaction rate or OFF position of FIG. 4A, control drums 20 are rotated to position lesser reflectors 44 proximate reactor core 12, increasing absorption of neutrons emitted from fuel assembly 18, and/or reducing reflection of neutrons back into or toward fuel assembly 18. As a result, the fission reaction rate is reduced, and reactor system 10 is shut down or produces less power.

Depending on configuration, fuel assembly 18 may be formed of a substantially uniform array of individual fuel blocks 21, for example in a close-packed hexagonal configuration as described above. A number of peripheral blocks 46 may also be provided along the outer circumference of fuel assembly 18, for example using a moderator or other matrix material 24, or additional reflector material 16. Peripheral elements 46 can also include additional internal channels 26 for cooling fluid or heat exchange, or for the introduction of control rods or other absorbing or moderating components.

When lesser reflector 44 is rotated near or toward (proximate) reactor core 12, relatively more neutrons from fuel assembly 18 are absorbed in control drum 20 and relatively fewer neutrons are reflected back from control drum 20 toward fuel assembly 18. This reduces or limits the number of available fission neutrons within reactor core 12, decreasing the fission rate within fuel assembly 18 and reducing the power output of reactor system 10.

In some such configurations, neutrons from fuel assembly 18 are absorbed within (or not reflected back from) lesser reflector 44 of control drum 20, sufficient to reduce the fission reaction rate below the level of a sustained nuclear chain reaction within reactor core 12. This may be referred to as a subcritical configuration of reactor system 10, in which control system 40 is operated to substantially shut off or shut down reactor core 12.

FIG. 4B is a schematic view of parasitic absorber-based control system 40 with rotary control drums 20 positioned in high reaction rate or ON position. In this configuration, lesser reflectors 44 are rotated away from reactor core 12, into a distal position with respect to fuel assembly 18. Thus, relatively fewer neutrons from fuel assembly 18 are absorbed in control drums 20, and relatively more neutrons are reflected back toward reactor core 12 to increase the fission rate within fuel assembly 18.

In some configurations, sufficient neutrons are reflected back from control drums 20 toward reactor core 12 to allow a controlled chain reaction to proceed within fuel assembly 18. This may be referred to as a critical (or substantially critical) configuration, in which control system 40 is operated to start or turn on reactor core 12 in order to generate energy or extract power from reactor system 10. Control system 40 can also be operated to regulate the fission reaction rate within fuel assembly 18, in order to increase or decrease the power output from reactor system 10 while reactor core 12 remains in a substantially critical configuration.

FIG. 4C is a detail view of a rotary control drum 20 for parasitic absorber control system 40 of FIGS. 4A and 4B. As shown in FIG. 4C, control drum 20 is formed of a primary reflector 42, with a neutron absorber or lesser reflector 44 provided along a selected portion of the external or outer surface 48.

The number and configuration of individual control drums 20 varies from design to design, along with the material composition, thickness, and other dimensions of neutron reflector 42. Suitable materials for neutron reflector 42 include, but are not limited to, beryllium oxide (BeO) and other neutron reflector materials such as beryllium, tungsten, tungsten carbide, lead, steel, and alloys thereof. Alternatively, materials with both neutron reflecting and neutron moderating properties may be utilized, for example graphite, or a combination of neutron reflecting and neutron moderating materials.

Lesser reflectors 44 are provided at one or more selected locations on or within outer surface 48 of control drum 20. Lesser reflectors 44 can be provided in discrete form, for example as chord-like shim 44A embedded within primary reflector 42, or in the form of a discrete layer 44B plated onto or embedded within outer surface 48. Alternatively, the material of lesser reflector 44 can be mixed homogenously into the material of reflector 42, at selected locations along outer surface 48.

Axially, lesser reflector 44 may extend substantially along the length or height of control drum 20, or along the corresponding axial length or height of reactor core 12. The angular extent of lesser reflector 44 along outer surface 48 of control drum 20 varies as a fraction of the total circumference, for example about ten to thirty degrees, about fifteen to twenty degrees, or about twenty degrees. In one particular example, lesser reflector 44 extends for about 18.75° along outer surface 48.

For reactor system 10 in the OFF (or reduced power) state, as shown in FIG. 4A, control system 40 rotates drums 20 to position secondary reflector (or control feature) 42 nearer reactor core 12, lowering reactivity (e.g., the fission reaction rate) by increasing the time it takes neutrons to be reflected back towards fuel assembly 18, and/or reducing the reflected neutron flux. For reactor energy 10 in the ON (or increased power) state, as shown in FIG. 4B, control system 40 rotates drum 20 to position lesser reflector 44 away from reactor core 12, increasing reactivity by positioning the more highly reflective primary reflector 42 nearer fuel assembly 18, reduction reflection time and/or increasing the reflected neutron flux.

The lesser reflector control option relies on a reduction in neutron reflection, or an increase in the average neutron mean free path in the reflecting region, in order to moderate the neutron economy. For this option, part of the primary reflector material 42 (e.g., BeO) in each control drum 20 is replaced with a control material 44 having lesser reflecting capabilities (e.g., aluminum, silicon, or steel). Suitable materials for lesser reflector 44 also include parasitic absorbers such as boron (B-10), boron carbide (B₄C), gadolinium (Gd), and hafnium (Hf), and lesser reflective materials such as aluminum (Al), silicon (Si), as well as steel and stainless steel. A composition of neutron absorbing and a lesser neutron reflecting material may also be used, for example borated silicon, borated aluminum, or borated steel.

In borated materials, the boron component provides a “burnable” nuclear poison, in which the neutron absorbing isotope boron-10 is consumed over time by one of two different neutron capture reactions. These are alpha decay to lithium-7, or (less commonly) gamma decay to stable boron-11:

^{10B+n→}¹¹B*→α+⁷Li. [2]

¹⁰B+n→¹¹B*+γ. [3]

The lesser reflector material (e.g., aluminum, silicon, steel, or stainless steel) has a reduced cross section for elastic neutron scattering, as compared to lesser reflector 44 (e.g., boron, boron carbonate, tungsten, or tungsten carbonate). Thus, the effective neutron capture and neutron reflection cross sections of lesser reflector 44 vary over time, based on the integrated neutron flux, allowing control system 40 to provide improved power regulation and energy capability over the extended service lifetime of reactor system 10.

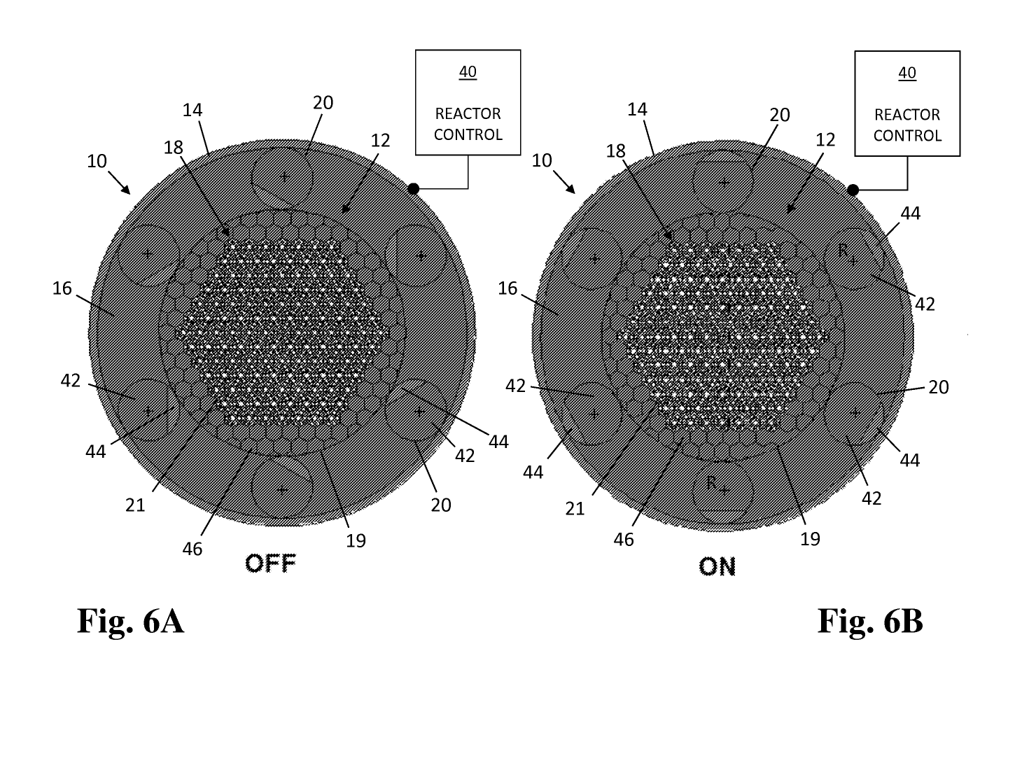

FIG. 5 is a plot (50) of scattering cross sections for some representative suitable neutron reflectors. The cross sections are given in barns (b) on the vertical axis, as a function of energy in electron volts (eV) on the horizontal. Cross sections are shown for titanium 48 (Ti-48, atomic number 22; line 51), elemental carbon (C, atomic number 6; line 52), aluminum 27 (Al-27, atomic number 13; line 53), silicon 28 (Si-28 atomic number 14; line 54), copper 63 (Cu-63, atomic number 29; line 55), elemental zinc (Zn, atomic number 30; line 56), and beryllium 9 (Be-9, atomic number 4; line 57).

Based on FIG. 5, elemental carbon in the form of graphite (line 52) may be a suitable replacement for beryllium (line 57) as a scattering medium, but graphite is also a neutron moderator and may not be suitable for reducing energy transfer to increase the number of scattering events in the epithermal region, with energy up to about 1 eV or less. Titanium (line 51), copper (line 55) and zinc (line 56) offer reductions in neutron scattering at thermal energies (about 1/40 eV) and at epithermal energies, but, like graphite, may have cross sections more similar to that of beryllium in the faster neutron region, above about 1 eV.

Aluminum (line 53) offers the largest reduction in cross section, as compared to beryllium (line 57). Both aluminum (line 53) and silicon (line 54), however, maintain a similar spectral shape, as compared to beryllium (line 57), and both aluminum (line 53) and silicon (line 54) offer almost an order of magnitude reduction in scattering cross section, over a wide range of incident neutron energies.

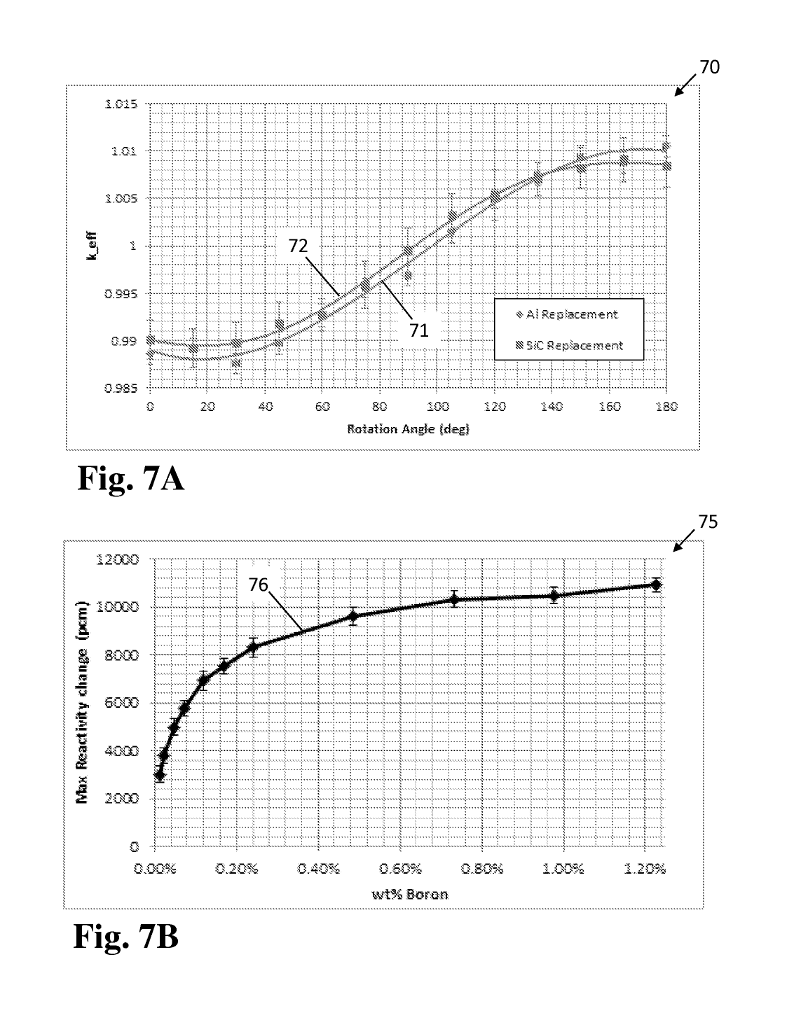

FIG. 6A is a schematic view of reactor control system 40 with borated lesser reflectors 44. A number (e.g., two, three, four, five, six or more) control drums or reflector controllers 20 are arranged about the outer circumference of reactor core 12. The rotational axis (R) of each control drum reflector (or reflector drum) 20 is oriented substantially parallel to the major axis of reactor core 12.

FIG. 6A shows control drums 20 rotated to a low reaction rate or OFF position for reactor system 10. In this configuration, lesser reflectors (secondary or “minor” reflectors) 44 are oriented toward reactor core 12, and positioned proximate fuel assembly 18 in order to reduce neutron reflection, increase neutron absorption, and lower the fission rate in reactor core 12. Primary reflectors 42 are positioned away from reactor core 12, and oriented distally with respect to fuel assembly 18.

FIG. 6B is a schematic view of reactor control system 40 as shown in FIG. 6A, with control drums 20 rotated to a high reaction rate or ON position. In this configuration, control drums 20 are rotated to orient lesser reflectors 44 away from reactor core 12, positioned distally from fuel assembly 18, in order to increase neutron reflection, reduce neutron absorption and increase the fission reaction rate in reactor core 12. Primary reflectors 42 are positioned toward reactor core 12, and proximate fuel assembly 18.

To determine suitable quantities of lesser reflector materials 44 in each control drum 20, reactor control system 40 was modeled in ON and OFF positions until the relative reaction rate or effective “multiplication factor” (k_{eff}) began to drop from an initial preselected threshold, for example about 1% excess radioactivity. The threshold was selected to determine a nominal proportion of lesser reflective material 44 that could be introduced into each control drum 20, without substantially changing the neutron properties of reactor core 12 and reactor system 10. In the particular configuration of FIGS. 6A and 6B, for example, the result was about 25% or less silicon carbide reflector material 42 by volume, or about 15% or less aluminum by volume.

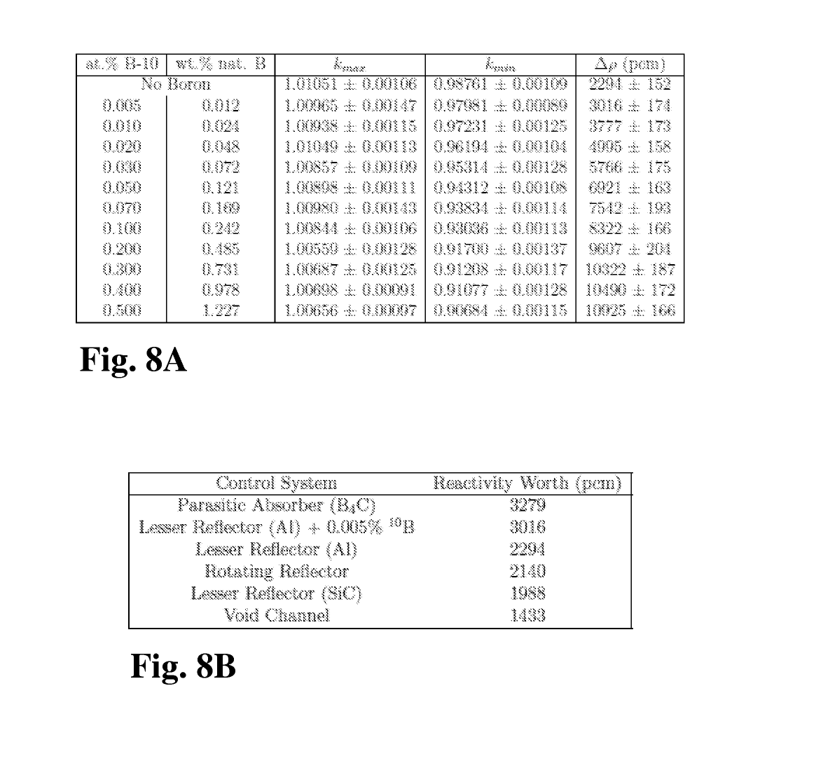

FIG. 7A is a plot (70) of representative effective reaction rates for reactor control system 40, as a function of control angle. In these particular examples, the reaction rate (k_{eff}) is plotted for lesser reflector materials comprising aluminum (Al; line 71) and silicon carbide (SiC; line 72), substituted for a reflector material comprising beryllium oxide (BeO). The control angle extends from an OFF position at rotation angle 0°, with the lesser reflector positioned directed toward the reactor core and oriented proximate the fuel assembly, to an ON position at rotation angle 180°, with the lesser reflector positioned away from the reactor core and oriented distally from the fuel assembly.

Generally, less aluminum (line 71) than silicon carbide (line 72) may be needed to provide a given control factor, because aluminum has a lower scattering cross-section. Thus, replacing the same proportion of beryllium (or BeO) scattering material with aluminum (Al) lesser reflector offers a greater reduction in neutron reflection, than may be achieved by replacing the same proportion with silicon (or silicon carbide).

The aluminum option can also provide for a greater control range and maximum power level, as shown in FIG. 7A, because there is more remaining scattering material in primary reflector 42 when control drums 20 are rotated to the ON position. Alternatively, silicon may be used to increase the proportion of lesser reflector in each control drum 20, or to achieve a different multiplication factor or relative reaction rate with control system 40 in the ON and OFF positions, respectively.

To further increase the effective control range, a borated lesser reflector material may be used, as described below. For example, borated aluminum or silicon carbide may be used, with a trace amount of naturally occurring boron, for example less than about 5% or less than about 2% by weight. Borated steel and stainless steel may also be used, with similar trace boron content.

FIG. 7B is a plot (75) of maximum reactivity swing for reactor control system 40 in the ON and OFF positions of FIGS. 6A and 6B, as a function of boron content in the lesser reflector. The reactivity swing (line 76) is given in thousandths of a percent or per cent mille (pcm), as shown on the vertical axis, at the beginning of lifetime (BOL) for the reactor. The boron content is shown on the horizontal axis, in percent by weight of naturally occurring boron (wt %).

As shown in FIG. 7B, the maximum reactivity swing (or change between on and off positions) increases substantially from 0% by weight to 8,000 pcm at about 0.2% boron content by weight, then less rapidly to about 10,000 pcm at about 0.5% boron content. Above about 0.5% boron content, the reactivity swing appears to approach an asymptote with a slope of about (1,500-2,000 pcm)/(wt %). In this particular example, a borated aluminum lesser reflector material is used, but other materials are also suitable, as described herein.

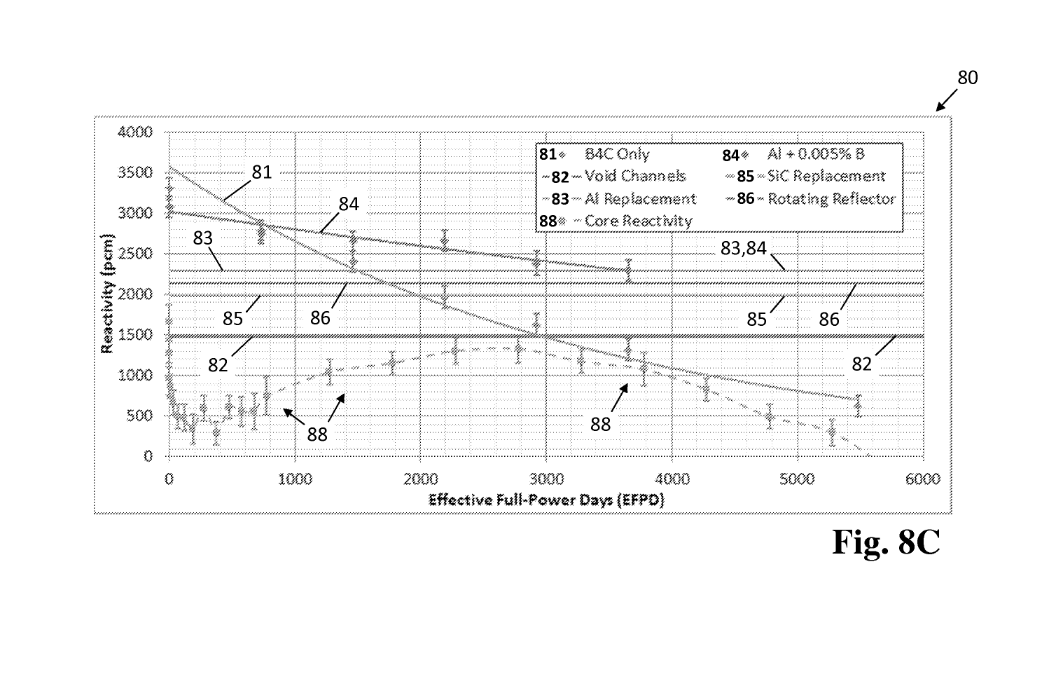

FIG. 8A is summary of control parameters for reactor control system 40, as a function of boron content in the lesser reflector. The maximum and minimum control factors (kₘᵢₙ and kₘₐₓ) are provided, along with the maximum reactivity swing. The boron content is given in percent weight natural boron for an aluminum lesser reflector, as in FIG. 7B. The atomic concentration of the boron-10 isotope is also provided, where boron-10 is the primary contributor to the neutron absorption cross section, as described above.

For more general configurations, FIGS. 8A and 8B indicate that a borated lesser reflector material with natural boron content of at least about 0.1% or at least about 0.2% by weight to about 0.5% by weight or less may provide substantial benefit in reactor control capability. This corresponds to boron-10 atomic concentration of at least about 0.005% to at least about 0.01%, or about 0.02% or less. In other applications, a natural boron content of about 0.5% to about 1.2% by weight may suitable, corresponding to an atomic boron-10 concentration of at least about 0.02% to about 0.05% or less.

Note that the numbers in FIG. 8A correspond to beginning of lifetime (BOL) values, and the boron-10 concentration will decrease over time. To achieve a reactivity worth of about 10,000 pcm or more at BOL, a natural boron content of more than about 0.5% by weight may be desired, for example about 0.75% or more, corresponding to an atomic boron-10 concentration of about 0.2% or more, or about 0.3% or more. When greater control capability is desired over the lifetime of the reactor, for example to address the change in reactivity and neutron production rates between reactor operations at beginning of lifetime (BOL) and end of lifetime (EOL), a /natural boron content of about 0.5% to about 1.0% or about 1.0% to about 1.2% or more may be desired, corresponding to a boron-10 atomic concentration of about 0.2% to about 0.5% or more.

The maximum suitable ranges of boron content also vary, for example about 2% or less natural boron content by weight, or about 1% or less boron-10 atomic concentration. Alternatively, the upper bound is larger, for example about 1% or above about 2% for either or both quantities.

FIG. 8B is a summary of reactivity worth values (Ap) for different control system designs, including a boron carbonate (B₄C) parasitic absorber, a borated aluminum (Al+B₄C) lesser reflector, an unborated (Al) lesser reflector, and a silicon carbide (SiC) lesser reflector. The reactivity worth is defined by kₒₙ and k_{off}, the effective multiplicative factors (k_{eff}) for the reactor control system in the ON and OFF positions, respectively:

$$Δ ρ = \frac{{k}_{on} - {k}_{off}}{{k}_{on} {k}_{off}} . \qquad [ 4 ]$$

As shown in FIG. 8B, the B₄C parasitic absorber configuration may have a relatively high reactivity worth, but this system is also subject to boron heating due to localized energy deposition, particularly due to the alpha decay process. While boron carbide may require additional cooling, however, a borated lesser reflector has substantially less boron-10 content, and commensurately lower thermal demands. FIG. 8B also describes rotating reflector and void channel designs, which can be utilized independently or in combination with the lesser reflector control elements, as described below.

In control systems utilizing boron absorbers, the amount of boron-10 available for absorption will decrease with core age, and this becomes an important operating consideration over the operating lifetime of the reactor. With typical core lifetimes of 10 to about 20 years, moreover, for example about 15 to 16 years or more, the remaining boron may become insufficient to adequately control the reactor, without taking boron depletion (or “burning”) into account.

The amount (N) of original boron-10 present at any given time (t) can be estimated from the original amount (Nₒ). Using the simple exponential depletion (or decay) equation:

N=N₀ e^{-kt}. [5]

The decay constant (k) depends on the total cross section for absorption (σₐ) and the neutron flux (φ). That is:

k=σₐφ. [6]

Modeling the flux (φ) and total cross-section (σₐ) in each of the control designs, a maximum reactivity change or swing can be calculated as the difference in reactivity from the ON position to the OFF position, over the lifetime of the reactor power system. The reactivity worth can be determined from the reactivity swing, allowing different designs to be compared.

An additional option or alternative to borated Aluminum is to consider using a mixture of two or more of the following materials: lead (e.g., Pb-208) and/or lead borate, aluminum (Al) and/or borated aluminum, and boron carbide (B₄C), in drums, reflectors or lesser reflectors with a different weight percentage of each material, for example from at least about 1-10% or more of each different material. As the boron-10 in the boron carbide or borated metal is depleted as a function of burnup or operational time (e.g., in effective full power days or EFPD), the Pb-208, Al and/or C components are left. The result is a significant improvement in backscattering of neutrons into the active core over the reactor lifetime, where the increased backscattered neutron flux provides for core life extension and more efficient fuel utilization. This design may also have a significant impact on the economics of the nuclear energy system, based on using Pb-208 in combination of borated Al as given below.

The effectiveness of using lead in the lesser reflector can be illustrated through examination of moderation, the neutron slowing process. Hydrogen has the highest moderating ability, with average logarithmic energy decrement ξ=1, where ξ=ln(Eᵢ/E_{f}) and Eᵢ/E_{f} is defined as the ratio of average initial neutron energy Eᵢ to average final neutron energy E_{f}. This value is approximately six times higher than that of carbon and beryllium, and the number of collisions required to slow down neutrons from an average initial energy Eᵢ of 1 MeV to an average final energy E_{f} of 0.5 eV is about N=14 in hydrogen, as compared to about N=92 in carbon. The carbon absorption cross-section, however, is about 82 times less than that of hydrogen. Therefore, the moderation ratio (MR=ξΣₛ/Σₐ) of hydrogen is comparable to that of carbon, where Σₛ is the macroscopic cross section for scattering, Σₐ is the macroscopic cross section for absorption, and MSDP=ξ×Σₛ is the macroscopic slowing down power.

TABLE 1
Neutronic Characteristic of Some Moderators

| | σₛ | | Number of Collisions | |
|---|---|---|---|---|
| Nuclide | (barns) | ξ | (1 MeV − 0.5 eV) | ξΣₛ/Σₐ |
| ¹H | 38 | 1 | 14 | 178 |
| ⁹Be | 7 | 0.21 | 70 | 143 |
| ¹²C | 4.8 | 0.16 | 92 | 192 |
| ²⁰⁸Pb | 11.5 | 0.0096 | 1514 | 477 |

The neutronic characteristics of some light elements are given in Table 1 for comparison. Table 1 shows that the elastic cross section of Pb-208 is higher than for Be-9 and C-12, but about N=1514 collisions are required to slow neutrons with an initial average energy Eᵢ of about 1 MeV down to a final average energy E_{f} of about 0.5 eV, due to the high atomic mass. This material is still more effective as a moderator than other solid materials, however, due to the very low absorption cross section of Pb-208 (about 0.23 mbarns).

As a result, Pb-208 (or naturally occurring lead containing Pb-208) can be a significantly better neutron reflector than graphite (C) or Be. Therefore, the overall lesser reflector effectiveness may be higher using either Pb-208 alone, or a combination of Pb-208 mixed with borated Al and/or other reflector materials such as boron carbide.

FIG. 8C is a plot (80) of maximum available reactivity worth for different reactor control system designs, as a function of core age or reactor service life. The reactivity worth is given on the vertical axis, in per cent mille (pcm). The time is given on the horizontal axis, in days of effective full power operation, or effective full power days (EFPD).

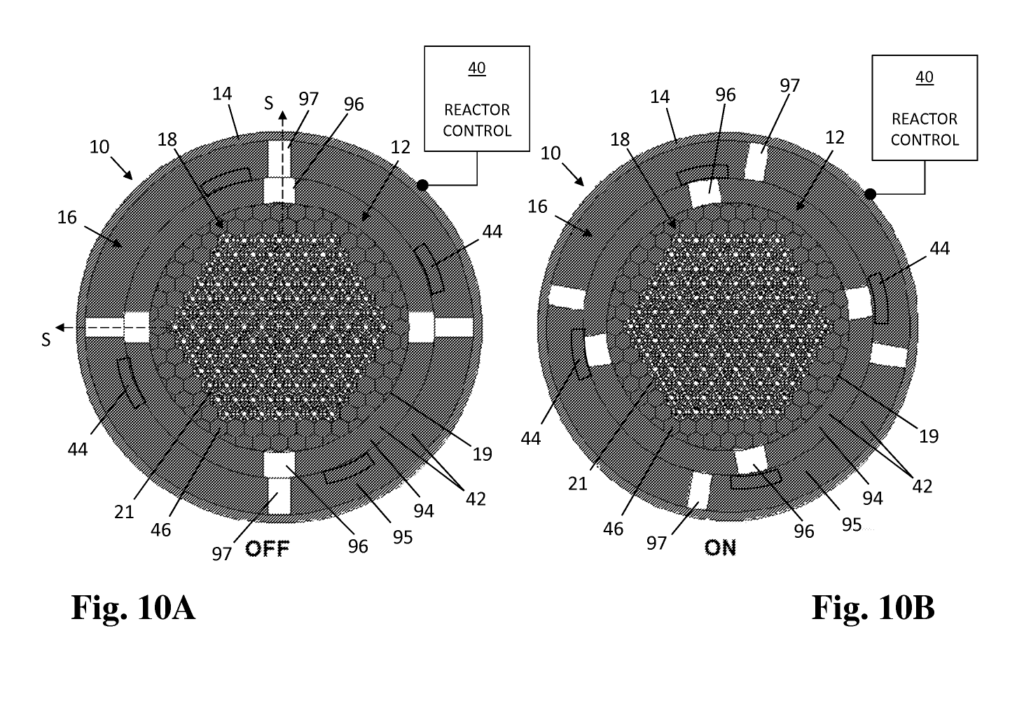

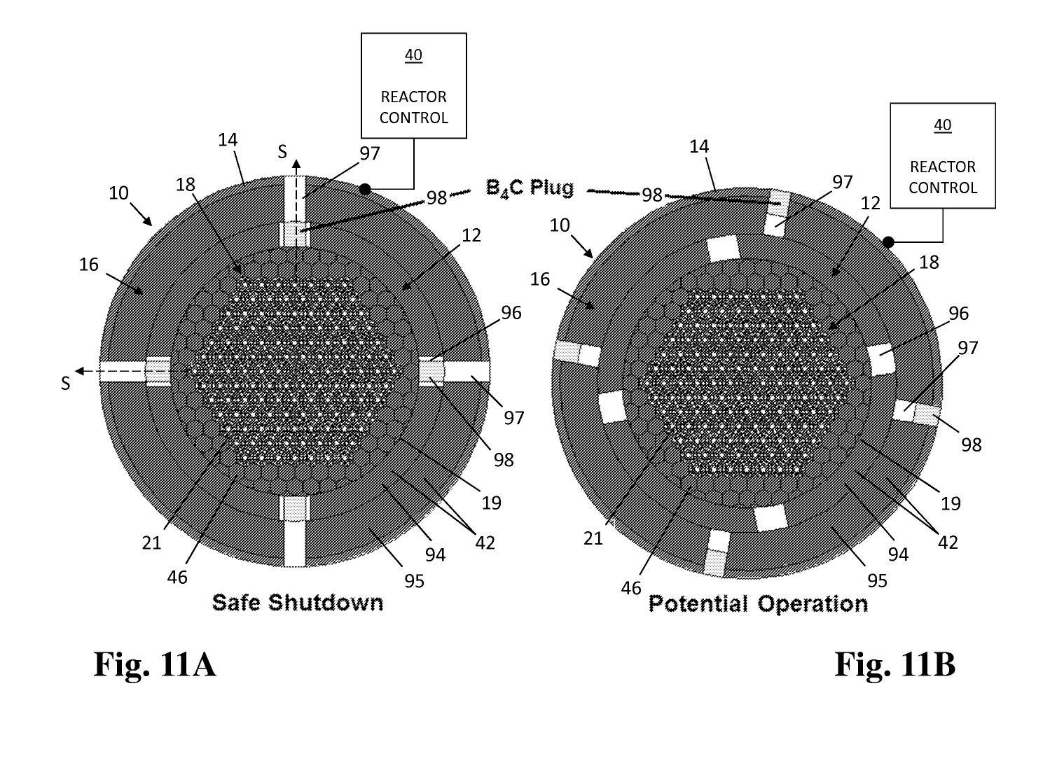

Reactivity worth plot 80 includes a boron carbide-only baseline option (no control drums, line 81), a void channel design (without lesser reflector, line 82), an aluminum lesser reflector (unborated, line 83), and a borated aluminum lesser reflector design (line 84). A silicon carbide lesser reflector is provided for comparison (line 85), along with an axially rotating reflector (without lesser reflector or boron absorber plugs, line 86 (see FIGS. 10A, 10B, 11A, 11B)).

Based on FIG. 8C, the boron carbide absorber design (line 81) may have a relatively high potential reactivity worth at beginning of lifetime (BOL), but this advantage is lost over the service lifetime. Ultimately, the reactivity worth of the boron carbide design decreases after about eight effective full-power running years (about 3000 EFPD, or half of anticipated lifetime), and potentially becomes the worst of the designs approaching the end of reactor lifetime (EOL).

The borated aluminum design (line 84) also loses some initial advantage in reactivity worth over time, but once the boron is substantially depleted (e.g., after about 3,000 to about 4,000 EFPD), the borated aluminum design and the “virgin” aluminum lesser reflector design (line 83) are substantially the same. Thus, at some point in time (e.g., after about half the expected reactor lifetime), the borated aluminum (line 84) and unborated aluminum (line 83) reactivity worth predications merge. The void channel and axially rotating reflector designs nominally have somewhat lower reactivity performance, but this may be improved with the use of additional lesser reflector materials, and other controller geometries.

From a thermal perspective, the goal of the reactor control system is to maintain system power over the greatest possible useful reactor lifetime, conserving the available fuel for the most efficient, long-term neutron production profile while controlling the reaction rate to prevent thermal damage to the reactor core and excess radioactivity exposure. In particular, reactor control parameters (e.g., drum or reflector position) must also take into account changes in the neutron spectrum of the reactor core over time, not only as a result of fuel depletion but also due to the production of neutron poisons and other fission products that absorb neutrons.

While these effects may require some reduction in the reflected neutron flux, particularly at beginning of lifetime (BOL) and in the first few years of reactor operations, there is a competing design constraint to avoid “wasting” neutrons, which could be used to generate power by inducing additional fission reactions. Control system operation thus also depends on the depletion of boron-10 and other absorbers in the control system, because the same control elements may provide more neutron absorption and less neutron reflectivity at beginning of lifetime (BOL), and less neutron absorption and more neutron reflectivity at end of lifetime (EOL). Thus, the rotational positions of the drums and other control elements will depend not only upon the evolving neutron production and fission reaction properties of the reactor core itself, but also rate of depletion or “burnup” of boron-10 in the borated lesser reflector, and in other boron components of the reactor control system.

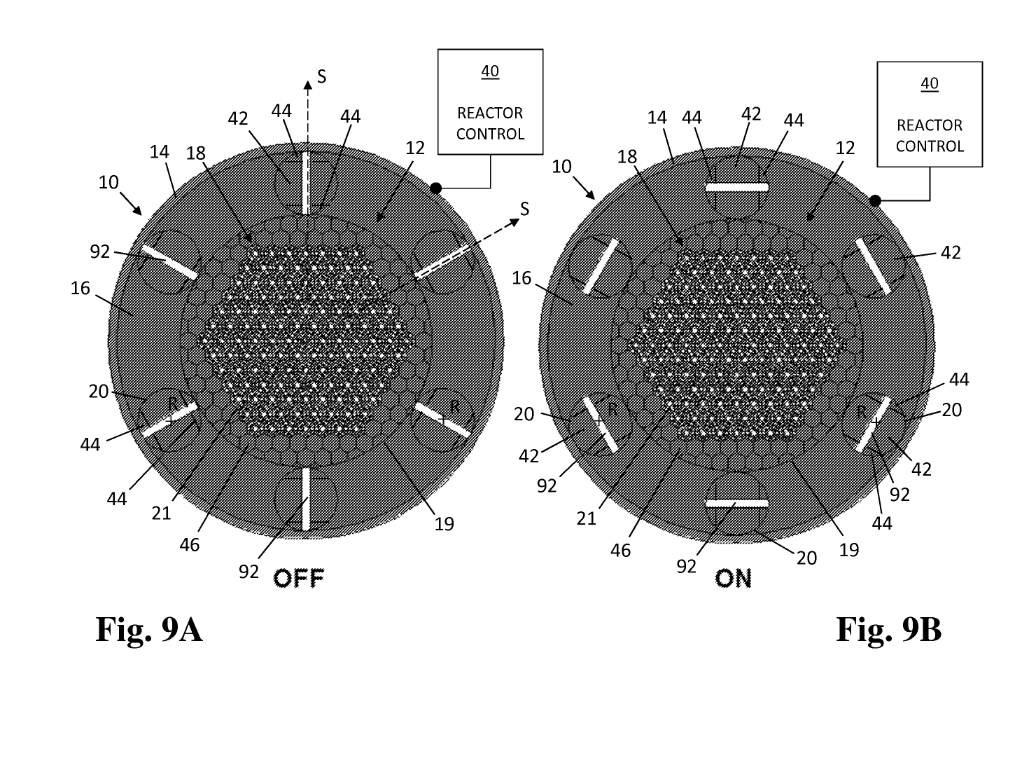

FIG. 9A is a schematic view of reactor control system 40 utilizing void channel control elements or drums 20, in a low reaction rate or OFF position. As shown in FIG. 9A, each control drum 20 is formed of a primary reflector 42 with a void or channel 92 extending diametrically there through, and one or more a secondary or lesser reflectors 44 positioned about the external circumference of control drum 20. In this symmetric configuration, channel 92 extends through primary reflector 42, between secondary or lesser reflector elements 44 on opposite sides of the outer circumference of control drum 20.

When control drum reflectors 20 are rotated to the off position, as shown in FIG. 9A, void channels 92 are oriented radially with respect to reactor core 12, generally parallel to the straight line path (or “light path”) S of neutrons emitted from fuel assembly 18. This increases the neutron leakage rate by allowing neutrons to pass through channel 92, rather than being reflected, reducing the reflected neutron flux and decreasing the fission reaction rate in reactor core 12. At least one lesser reflector 44 can also be positioned toward reactor core 12, proximate fuel assembly 18, further reducing the reflected neutron flux. A neutron poison or absorber material can also be included in lesser reflector 44, for example using a borated metal as described above, in order to increase absorption and further reduce the reflected neutron flux.

FIG. 9B is a schematic view of reactor control system 40 as shown in FIG. 9A, with control drums 20 oriented rotate to an increased reaction rate or ON position. In this configuration, channels 92 are oriented transversely with respect to reactor core 12, generally perpendicular to the path of neutrons emitted by fuel assembly 18. In this configuration, the primary reflector 42 is positioned toward reactor core 12 and proximate fuel assembly 18, increasing the reflected neutron flux and the corresponding fission rate. Any parasitic neutron poison or other absorber in lesser reflectors 44 is positioned away from reactor core 12, reducing neutron capture.

The geometries of individual channels 92 vary based on control system design. In one example, each channel 92 is formed as a void in primary reflector 42, for example with a substantially square, rectangular or circular cross section. A number of individual channels 92 can also be formed in each primary reflector or control drum 20, oriented in a parallel configuration and arranged in series along the rotational axis. In one particular application, a set of parallel circular channels 92 is formed in each control drum 20, for example with a diameter of about 2 cm, or about 10-20% of the diameter of control drum 20, and with a void fraction of about 10-20% or 15-20% of the drum volume, for example about 17%.

FIG. 10A is a schematic view of an axially rotating reactor control system 40, in a low reaction rate or OFF position. In this configuration, neutron reflector 16 is split into two or more nested, coaxial radial zones or annular drum reflectors (“control rings”) 94 and 95, which are formed of primary reflector material 42. A number (e.g., one, two, three, four or more) of complementary radially extending channels 96 and 97 are arranged about the circumference reactor core 12, extending through the radial thickness of annular drum reflectors 94 and 95, respectively.

One or both of annular drum reflectors 94 and 95 are rotatable about the axis of reactor core 12. For example, inner annular drum or ring 94 may be considered a primary reflector, rotating coaxially within outer ring or secondary reflector 95. Alternatively, outer (secondary) reflector 95 may rotate coaxially about inner (primary) reflector 94, or primary reflector 94 may be disposed about secondary reflector 95.

In the OFF position of FIG. 10A, for example, one or both of annular drums (primary and secondary reflectors) 94 and 95 are rotated to align complementary and corresponding control channels 96 and 97 along the radial line of sight path S of neutrons emitted from fuel assembly 18. As in the example of FIG. 9A, this increases the neutron leakage rate, decreases the reflected neutron flux, and reduces the corresponding neutron-induced fission rate within reactor core 12.

FIG. 10B is a schematic view of axially rotating control system 40 as shown in FIG. 10A, with one or both of annular (or cylindrical) drum reflectors 94 and 95 rotated to a high reaction rate or ON position. In this position, complementary radial channels 96 and 97 are misaligned, for example by a relative axial rotation of about 10-20° or more, closing off the straight-line escape path to increase the reflected neutron flux and corresponding fission rate inside reactor core 12.

In some embodiments, lesser reflector material 44 may also be provided, for example in selected regions of the inner circumference of outer annular reflector 95. This allows relative rotation of annular drum reflectors 94 and 95 to introduce either primary reflector 42 or lesser (secondary) reflector 44 into the neutron path, in order to further modulate the reflected neutron flux for improved reactor rate control. Alternatively, the relative leakage rate and reflected neutron flux can be regulated by partially aligning complementary inner about outer control channels 96 and 97, varying the neutron-induced fission rate in reactor core 12 according to the open cross-sectional area long each escape path S.

The relative size and configuration of annular drums 94 and 95 vary, along with the corresponding dimensions of radial channels 96 and 97. In particular, inner drum or ring reflector 94 may have a radial thickness of about 30-50% of the total thickness of neutron reflector 16, producing a radial split in the range of about 70/30 to 60/40 or 50/50, as defined by the ratio of outer and inner ring thickness, as a fraction of the whole thickness. Alternatively, inner ring reflector 94 may have a substantially smaller thickness than outer ring reflector 95, for example about 10-30% of the total thickness. Inner annular ring 94 may also have a greater thickness than outer ring reflector 95, in similar but complementary proportions.

Inner and outer channels 96 and 97 can be formed as voids within primary reflector material 42, for example with a circular, square, rectangular, hexagonal or other cross sectional geometry, as described above. In addition, a number of generally parallel radial channels 96 and 97 can be distributed along the axial length or height of each annular reflector 94 and 95, in either a staggered or aligned (“stacked”) configuration.

Inner control channels 96 can also be somewhat larger or smaller in cross sectional area than outer channels 97, in order to make angular alignment relatively easier, or to provide for more precision in relative angular positioning. The diameters of individual channels 96 and 97 also vary, for example from about 35-50% or less of the radial thickness of the corresponding annular reflectors 94 and 95, to about 70-150% or more. In an aligned configuration, the neutron leakage or “escape” paths formed along control channels 96 and 97 may approach up to 10-20% or more of the total reflector volume, or of the total surface area of reactor core 12.

FIG. 11A is a schematic view of axially rotating reactor control system 40 as shown in FIG. 10A, with absorber plugs 98 positioned in a shutdown configuration. Neutron absorber plugs 98 are formed of suitable neutron absorbing material, for example boron carbide or another neutron poison.

As shown in FIG. 11A, one or more neutron absorber plugs 98 can be positioned or slid into inner control channels 96 next to reactor core 12, in order to partially or substantially completely block one or more neutron escape paths S. Inner and outer annular reflectors 94 and 95 can either be aligned in this configuration, as shown in FIG. 10A, or rotated to a misaligned position, as shown in FIG. 10B. Alternatively, one or more absorber plugs 98 can be positioned proximate reactor core 12 in control channels 92 formed in a drum reflectors 20, as shown in FIGS. 9A and 9B.

Neutron absorber plugs 98 can be positioned in the “safe shutdown” configuration of FIG. 11A to increase the neutron absorption rate and decrease the reflected neutron flux sufficiently to make reactor system 10 subcritical, shutting down the fission chain reaction in reactor core 12. Neutron absorber plugs 98 can also be deployed as a proactive safety measure, for example to reduce the likelihood that reactor core 12 accidentally starts up or goes critical during manufacture, assembly, transportation, deployment, testing and other operations.

Depending on void proportion and control channel configuration, neutron absorber plugs 98 can also be positioned to reduce the likelihood accidental water entry into inner control channels 97, which could result in a critical event due to the reduced neutron leakage rate and water's neutron moderating properties. Neutron absorber plugs 98 can thus be provided to reduce the likelihood of reactor accident during a forced water re-entry, or accidental immersion of reactor system 10.

FIG. 11B is a schematic view of axially rotating reactor control system 40 as shown in FIG. 10B, with absorber plugs 98 positioned in an operating configuration. Absorber plugs 98 can be positioned or slid in and out of inner control channels 96 into outer control channels 97, with inner and outer annular reflectors 94 and 95 rotated to an aligned or unaligned position, blocking or opening straight-line paths S for neutron leakage.

The operating configuration of FIG. 11B reduces the neutron absorption and leakage rates, and increases the reflected neutron flux to a level sufficient to sustain a chain reaction in reactor core 12 for power generation by reactor system 10. If shutdown is desired, one or both of inner or outer annular reflectors 94 and 95 can be rotated to align inner and outer control channels 96 and 97, positioning absorber plugs 98 in the neutron path and reducing the reflected flux sufficiently to shut down reactor core 12. Alternatively, one or more absorber plugs 98 can be removed from reactor system 10 during operation, and replaced when reactor shutdown is desired.

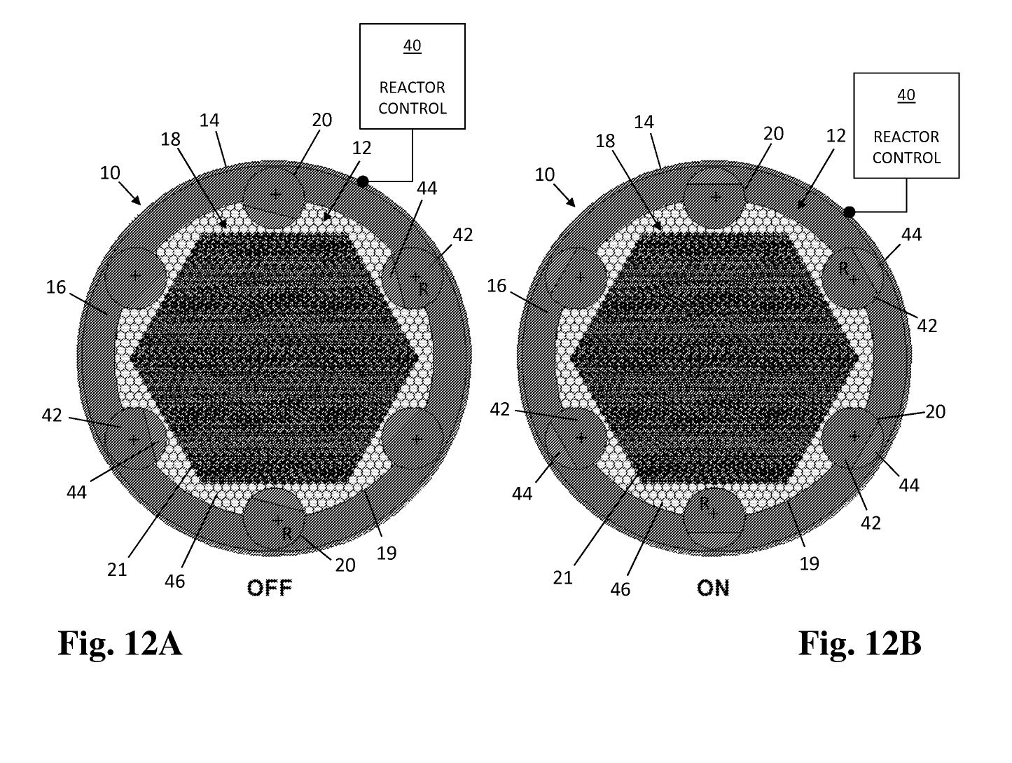

FIG. 12A is a schematic view of reactor control system 40 with increased size control drums 20. In this configuration, control drums 20 extend through core barrel 19 into peripheral (e.g., moderator) blocks 46, in order to position primary reflector 42 or secondary (lesser) reflector 44 closer to fuel blocks 21 in fuel assembly 18. This provides increased control over the neutron absorption rate and reflected neutron flux, as compared to the smaller (external) barrel designs of FIGS. 6A and 6B, for greater reactor power control.

In the low power or OFF configuration of FIG. 12A, control drums 20 are rotated to position lesser reflector 44 toward reactor core 12. This increases absorption and reduces the reflected neutron flux, in order to decrease the fission reaction rate in fuel assembly 18.

FIG. 12B is a schematic view of reactor control system 40 as shown in FIG. 12A, with control drums 20 rotated to a high reaction rate or ON position. In this configuration, primary reflector material 42 is positioned toward reactor core 12, increasing the reflected neutron flux and corresponding fission reaction rate.

Note that the rotational positions of individual control drums or reflectors 20 can be the same or individual controlled, for example in the event reactor core 12 has non-uniform thermodynamic performance, or when another asymmetric control configuration is required. Control system 40 can also be configured to rotate individual drums 20 to accommodate a “stuck rod” (or stuck drum) event, in which one or more control drums 20 cannot be rotated.

In this configuration, the other (functional) control drums 20 can be individually positioned to increase or decrease the fission rate accordingly, for example to reduce the fission rate in sections of reactor core 12 adjacent to a control drum stuck in the ON position, in order to avoid thermal damage to fuel assembly 18. Alternatively, the other (functional) control drums 20 can be individually rotated to increase the neutron flux in sections of reactor core 12 adjacent to a control drum stuck in the OFF position. The materials of primary reflector 42 and lessor or secondary reflector 44 can also be selected for substantially uniform density, in order to provide rotational balance and reduce vibrations and asymmetric torque during rotation of control drums 20 (or annular drums 94 and 95, see FIGS. 10A, 10B, 11A and 11B).

Reactor control is thus achieved through an innovative approach to the conventional boron carbide neutron absorber, for example by utilizing sections of borated aluminum placed in rotating control drums within the reactor. Borated aluminum allows for smaller boron concentrations, reducing or substantially eliminating the potential for ¹⁰B(n,α)⁶Li reactions and other heating issues, which are common in other (e.g., boron carbide) systems. A wide range of other reactivity control systems are also encompassed, such as a radially-split rotating reactor and the other reactor configurations described herein.

Extensions to both space-based and terrestrial energy systems are also encompassed, for example with uranium enrichment dropped by up to 20% or more in order to meet regulatory and/or design requirements. A solid uranium-zirconium hydride fissile driver may also be used in place of the uranium dioxide or TRISO fuel particles, and a graphite moderating material can also be employed, as an alternative to beryllium oxide. The core size may also be increased, while maintaining or increasing long-term power generation potential. Small amounts of erbium can also be added to the hydride matrix, in order to further extend core lifetime.

While this invention has been described with reference to exemplary embodiments, it will be understood by those skilled in the art that various changes can be made and different equivalents may be substituted for particular elements thereof, without departing from the spirit /and scope of the invention. The invention is thus not limited to the particular examples that are disclosed, but can also be adapted to different problems and situations and applied to different materials and techniques, without departing from the essential scope of embodiments encompassed by the appended claims.

1. A reactor system comprising:
a reactor core comprising a fuel assembly or fuel block, the fuel assembly or fuel block generating a neutron flux;
a reactor vessel disposed about the reactor core;
at least one control element disposed within the reactor vessel, the control element comprising a primary reflector configured to reflect a portion of the neutron flux back to the reactor core;
a lesser reflector disposed on a selected surface of the control element, the lesser reflector comprising boron and a metal; and
a control system configured to regulate the neutron flux based on a rotational position of the control element with respect to the reactor core, wherein the reflected portion of the neutron flux is substantially greater with the primary reflector disposed toward the reactor core than with the lesser reflector disposed toward the reactor core.

2. The reactor system of claim 1, wherein the lesser reflector comprises borated aluminum having a boron-10 concentration that decreases as a function of exposure to the neutron flux.

3. (canceled)

4. (canceled)

5. The reactor system of claim 2, wherein the control system is configured to rotate the control element about an axis in order to regulate the reflected neutron flux as a function of the boron-10 concentration in the borated aluminum.

6. The reactor system of claim 5, wherein the borated aluminum has content of naturally occurring boron between about 0.1% and about 2.0% by weight or more based on core configuration.

7. (canceled)

8. The reactor system of claim 1, wherein the at least one control element comprises a plurality of control drums disposed about a circumference of the reactor core, and wherein the control system is configured to rotate the plurality of control drums about individual rotational axes in order to regulate the reflected portion of the neutron flux.

9. (canceled)

10. (canceled)

11. (canceled)

12. (canceled)

13. The reactor system of claim 1, wherein the primary reflector comprises a reflector ring disposed about the reactor core and the control element comprises a control ring coaxially disposed about the reactor core with the primary reflector, the control ring comprising a plurality of control channels configured to decrease the reflected portion of the neutron flux by providing a leakage path when rotated into alignment with corresponding channels in the primary reflector.

14. (canceled)

15. The reactor system of claim 1, wherein the lesser reflector comprises lead.

16. (canceled)

17. (canceled)

18. (canceled)

19. A reactor control system comprising:
a plurality of control drums disposed about a circumference of a reactor core, each of the control drums comprising a primary reflector configured to reflect a neutron flux back toward the reactor core; and
a lesser reflector disposed on a selected surface of each control drum, the lesser reflector comprising a metal and having a boron-10 concentration that decreases with exposure to the neutron flux;
wherein a fission reaction rate within the reactor core is regulated by rotating the plurality of control drums about individual axes, and wherein the reflected neutron flux is greater with the primary reflector disposed toward the reactor core than with the lesser reflector disposed toward the reactor core.

20. The reactor control system of claim 19, wherein the fission reaction rate is regulated as a function of the boron-10 concentration in the lesser reflector.

21. The reactor control system of claim 19, wherein lesser reflector comprises borated aluminum having a naturally occurring boron content between about a 0.1% and about 1.2% by weight or more.

22. The reactor control system of claim 19, wherein the lesser reflector comprises lead.

23. (canceled)

24. The reactor control system of claim 19, wherein the lesser reflector extends axially along substantially a height of the control drum, and circumferentially about the control drum over an angular range of between about 10% and about 30%.

25. The reactor control system of claim 19, further comprising at least one control channel extending diametrically through each of the control drums, the control channels are configured to reduce the reaction rate by providing neutron leakage paths when oriented radially with respect to the reactor core.

26. (canceled)

27. (canceled)

28. A method of reactor control, the method comprising:
rotating a plurality of control drums disposed about a circumference of a reactor core, each of the control drums comprising a primary reflector configured to reflect the neutron flux and a lesser reflector disposed on a selected surface thereof, the lesser reflector comprising a metal and having a boron-10 concentration that decreases with exposure to the neutron flux; and
controlling a fission reaction rate within the reactor core based on the reflected neutron flux, wherein the reflected neutron flux depends upon a rotational position of each control drum, and wherein the reflected neutron flux is higher with the primary reflector disposed toward the reactor core than with the lesser reflector disposed toward the reactor core.

29. The method of claim 28, further comprising starting the reactor core by rotating the control drums from a position with the lesser reflectors oriented toward the reactor core such that the reactor core is subcritical, to a position with the lesser reflectors oriented at least partially away from the reactor core such that the reactor core is critical.

30. The method of claim 29, further comprising rotating the control drums to position the lesser reflectors with respect to the reactor core as a function of the boron-10 concentration.

31. The method of claim 30, further comprising rotating the control drums to increase a reactivity worth of the reactor, as compared to rotating similar control drums having lesser reflectors without the boron-10 concentration.

32. The method of claim 28, wherein the metal comprises at least one of lead and aluminum.

33. The method of claim 32, wherein the metal comprises borated aluminum.

34. The method of claim 32, wherein the lesser reflector further comprises boron carbide.

35. (canceled)

36. (canceled)

37. (canceled)

38. (canceled)

39. (canceled)

40. (canceled)
